(19) United States
(12) Patent Application Publication
(10) Pub. No.: US 2024/0248969 A1
(43) Pub. Date: Jul. 25, 2024

(54) SYSTEM FOR DELEGATION BASED ON DECENTRALIZED IDENTITY AND METHOD THEREOF

(71) Applicant: K4-security.co., Ltd., Seoul (KR)

(72) Inventor: Kyoung Chul PARK, Gimpo-si (KR)

(21) Appl. No.: 18/465,800

(22) Filed: Sep. 12, 2023

(30) Foreign Application Priority Data
Jan. 19, 2023 (KR) 10-2023-0008074
May 19, 2023 (KR) 10-2023-0064968

(51) Int. Cl. G06F 21/31

(52) U.S. Cl. CPC G06F 21/31

(57) ABSTRACT

A system and method for delegation are based on a decentralized identifier capable of delegating an act of a legal entity through applying a blockchain-based decentralized identifier technology that guarantees self-sovereign identity. According to an embodiment, a specific act of a legal entity may be delegated to a deputy for a specific period of time based on a decentralized identifier.

### CROSS-REFERENCE TO RELATED APPLICATIONS

This application claims priority from Korean Patent Application No. 10-2023-0008074, filed on Jan. 19, 2023, and Korean Patent Application No. 10-2023-0064968, filed on May 19, 2023, in the Korean Intellectual Property Office, each of which is incorporated herein by reference in its entirety.

### BACKGROUND OF THE INVENTION

### Field of the Invention

The present disclosure relates to a system for delegation based on a blockchain, and more particularly, to a system and method for delegation based on a decentralized identifier capable of delegating an act of a legal entity through applying a blockchain-based decentralized identifier technology that guarantees self-sovereign identity.

### Background of the Related Art

A digital ID (digital identifier), such as an ID, a resident registration number, an e-mail address, an address, a joint certificate, or the like, is used as a means capable of verifying one's own identity on the Internet. However, with the improvement of Internet technology, the importance of storage and management technology for security along with a series of convenience and efficiency enhancement has also increased in recent years, and accordingly, digital ID management technology has also evolved and changed. As numerous sites were created in the early days, the inconvenience of having to register repeatedly in that a user registration process was required for each site and problems with convenience in terms of managing account information on multiple sites have been emerged. In order to solve the foregoing problems, a centralized model for single sign-on (SSO), which allows a user to use multiple sites with a single login to the multiple sites, has been proposed. Furthermore, the centralized model has a disadvantage of lacking scalability for ID utilization or the like in that all user information is centrally managed, and has been developed into a federated model to compensate therefor. However, in the case of both models, simple registration and authentication procedures can be performed from the user's point of view, but there are clear limitations in that security and control rights are not guaranteed from the point of view of personal information. That is, the foregoing models have limitations on the safety of digital IDs. Due to these limitations, a user has to provide personal information unrelated to the service, which soon leads to the leakage of a lot of personal information. In 2016, Alan Christopher first proposed a self-sovereign identity (SSI) model that allows the user, who is a subject of personal information, to have a direct control authority to solve the relevant problem. Based thereon, in recent years, studies on a decentralized identity (DID) using a distributed ledger technology (DLT) such as a blockchain are being actively carried out. Among them, a blockchain-based decentralized identifier (DID) technology is being designed and studied under the lead of the Decentralized Identity Foundation (DIF), and the relevant technology was recently announced and approved as a web standard by the World Wide Web Consortium (W3C) on Jul. 10, 2022.

On the other hand, the related obligation of a public certificate, which had been used as a representative among digital authentication technologies, has been deleted due to the revision of the Electronic Signature Act in December 2020, and thus is currently being used under the name of a “joint certificate”. However, unlike the abolition of the obligation, there is still no way to strongly replace it in some services in reality, so the joint certificate is still being used in numerous fields such as tax inquiries to the National Tax Service and Internet banking based thereon. The joint certificate has a public key infrastructure (PKI), and corresponds to a type of digital identification card created by adding its owner's information to a public key required for verification.

However, in terms of structure, a joint certificate system is a centralized model premised on a trust-third party (TTP) that plays a role in safely distributing keys, so there exist clear limitations to its efficiency and security. In addition, while performing digital identity-based delegation, which is frequently used in real environments, when a representative of a corporation who receives a corporate certificate as a deputy performs a specific act, it is impossible to perform an accurate check on a deputy since the authentication of the representative is not actually performed, and there exist no information of the representative who is the deputy within the certificate. This expose a loophole in that a submitter submitting an actual corporate certificate cannot be checked as a real deputy. That is, even when a malicious third party learns and uses a joint certificate file and a valid password through an attack such as social engineering, there is no way to verify whether the third party is a real deputy. In this respect, there is a very big problem that it is impossible to perform accurate verification on the deputy. Therefore, in order to supplement the fundamental problems in the centralized model and the actual use of a joint certificate, blockchain-based decentralized identifier (DID) technology that can realize self-sovereign identity is essential, and thus it is necessary to design a new delegation model based on a decentralized identifier (DID) that can be clearly verified with each other, which can solve the aforementioned problems of the joint certificate.

In addition, according to the W3C DID Core v1.0 specification, which is a current decentralized identifier (DID) standard model, there is no constraint on a subject to which a decentralized identifier (DID) is to be issued. However, when a holder who holds a decentralized identifier submits a verifiable presentation (VP), an act of signing is required for the holder, and unless it is not an act of signing through an automatic algorithm, a subject (ownership entity) to which the decentralized identifier is to be issued must be a person. In such a constrained environment, it is somewhat inappropriate to apply a current decentralized identifier (DID) model to a non-human entity such as a corporation, which requires a decentralized identifier (DID)-based delegation technology for a series of entities such as corporations and foundations.

### SUMMARY OF THE INVENTION

The present disclosure provides a system and method for delegation based on a decentralized identifier that delegates authority for a specific act for a specific period of time when an act of a legal entity such as a corporation, a foundation, a school, and a national ministry is required, thereby allowing a deputy who has received delegation to perform the authority on behalf of the legal entity.

Technical problems to be solved in the present disclosure may not be limited to the above-described problems and other technical problems, which are not mentioned herein, will definitely be understood by those skilled in the art from the following description.

According to an aspect of the present disclosure, there is provided a system for delegation based on a decentralized identifier.

The system for delegation based on a decentralized identifier according to an embodiment of the present disclosure may include an issuer that checks a deputy's and a delegator's identity information and issues a delegated credential for delegation, a verifier that retrieves and verifies the meta data of the decentralized identifier, and a registry that stores the meta data of the decentralized identifier.

According to another aspect of the present disclosure, there is provided a method for delegation based on a decentralized identifier and a computer program executing the same.

The method for delegation based on a decentralized identifier according to an embodiment of the present disclosure may include receiving a request for delegation from a deputy, issuing a delegated credential, receiving a request for verification to perform a delegation act, verifying that the delegation act has been authorized, and allowing the deputy to perform a delegation act.

According to an embodiment of the present disclosure, a specific act of a legal entity may be delegated to a deputy for a specific period of time based on a decentralized identifier.

According to an embodiment of the present disclosure, a blockchain-based decentralized identifier technology that guarantees self-sovereign identity may be applied thereto, thereby performing detailed verification on a deputy who has received delegation.

Furthermore, according to an embodiment of the present disclosure, batch verification on a multi-signature may be applied thereto, thereby more efficiently performing signature verification on a case where there exist several participants, such as delegation of a legal entity, than the existing model.

According to an embodiment of the present disclosure, signatures of multiple participants at different signing and signature verification times may be securely encrypted into a single signature, thereby allowing signature verification of a legal entity including the signatures of multiple participants to be performed in real time.

It is to be understood that the effects of the present disclosure are not limited to the foregoing effects, and include all effects that may be deduced from the features described in the detailed description of the invention or the claims.

### BRIEF DESCRIPTION OF THE DRAWINGS

FIG. 1 is a diagram for explaining the W3C DID v1.0 standard model.

FIGS. 2 and 3 are diagrams for explaining a system for delegation based on a decentralized identifier according to an embodiment of the present disclosure.

FIG. 4 is a diagram illustrating a method for delegation based on a decentralized identifier according to an embodiment of the present disclosure.

FIGS. 5 to 7 are exemplary diagrams of a method for delegation based on a decentralized identifier according to an embodiment of the present disclosure.

FIGS. 8 to 10 are examples of scenarios of a system for delegation based on a decentralized identifier according to an embodiment of the present disclosure.

### DESCRIPTION OF SYMBOLS

10: System for delegation based on decentralized identifier
20: Delegator
30: Deputy
100: Issuer
200: Verifier
300: Resolver
400: Registry

### DETAILED DESCRIPTION OF THE PREFERRED EMBODIMENT

various modifications can be made and diverse embodiments are applicable to the present disclosure, specific embodiments will be illustrated with reference to the accompanying drawings and described in detail through the detailed description. However, those specific embodiments should not be construed to limit the present disclosure, and should be construed as being extended to all modifications, equivalents, and substitutes included in the concept and technological scope of the invention. In describing the embodiments of the present disclosure, the detailed description will be omitted when a specific description for publicly known technologies to which the invention pertains is judged to obscure the gist of the present disclosure. A singular expression as used in the specification and the claims is generally to be construed as meaning “one or more” unless indicated otherwise.

Hereinafter, preferred embodiments of the present disclosure will be described in detail with reference to the accompanying drawings, and the same or similar elements are designated with the same numeral references regardless of the numerals in the drawings and redundant description thereof will be omitted.

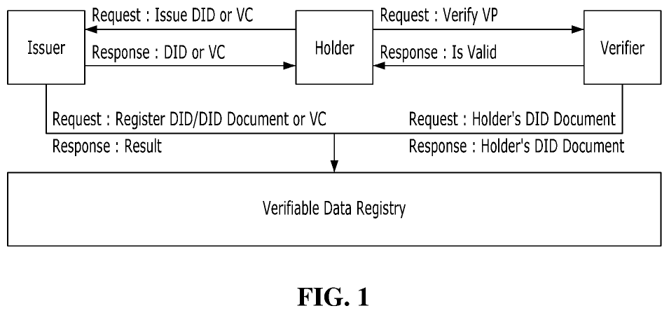

FIG. 1 is a diagram for explaining the W3C DID v1.0 standard model.

Referring to FIG. 1, a decentralized identifier (DID) standard model defined by W3C DID v1.0 includes an issuer who issues a decentralized identifier (DID) and a verifiable credential (VC), a holder who is a subject that receives and holds the decentralized identifier (DID) and the credential (VC) issued from the issuer who can guarantee his or her own identity, and a verifier that verifies the verifiable credential (VC) to determine whether to provide a service. Here, metadata for the issued decentralized identifier is stored in a verifiable data registry and is retrieved for verification.

According to the current W3C DID core v1.0 specification, there are no limitations on a subject to which a decentralized identifier (DID) is to be issued. However, when a holder selects a credential to submit a verifiable presentation (VP), an act of signing is required to authenticate that it is his or her presentation. If it is not an act of signing through an automatic algorithm, a subject to which a decentralized identifier (DID) is to be issued must be a person. In such a constrained environment, for an entity endowed with personality, such as a corporation, which means an organization whose legal capacity is recognized by law, a deputy is required to perform a specific act, such as an act of signing.

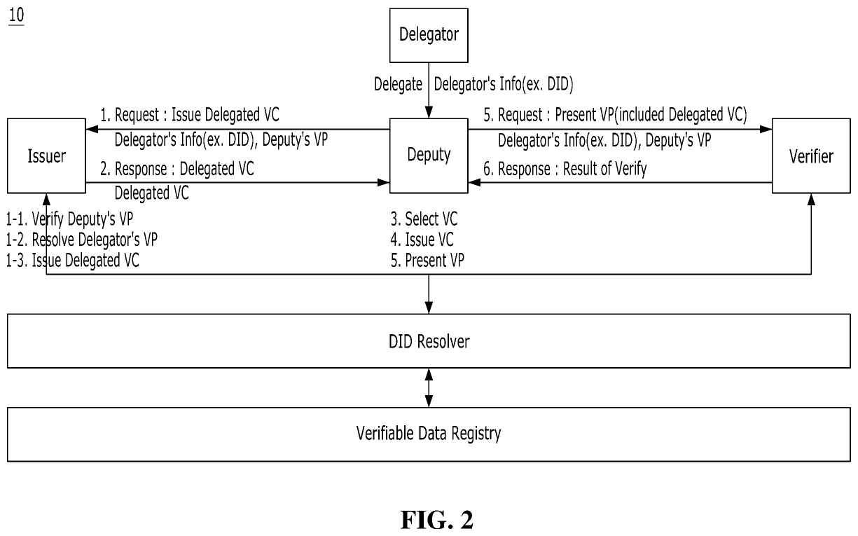

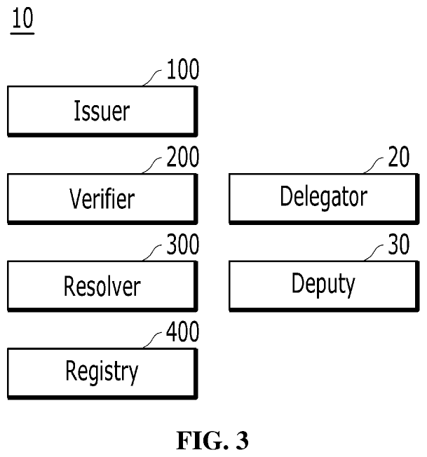

FIGS. 2 and 3 are diagrams for explaining a system for delegation based on a decentralized identifier according to an embodiment of the present disclosure.

Referring to FIG. 2, in the system 10 for delegation based on a decentralized identifier, when an act by a legal entity is required, a deputy delegated with a specific act may perform the act.

The system 10 for delegation based on a decentralized identifier may delegate authority for some acts of a legal entity for a specific period of time, thereby allowing a deputy to perform the acts on behalf of the legal entity. Here, the legal entity may include a corporation, a foundation, a school, a national ministry, an organization, or the like.

A deputy is a subject who receives delegation, and delegation certification is required to perform a delegation act authorized by a delegator.

A delegator is a subject who grants delegation, and shares delegation information such as the delegator's decentralized identifier to the deputy in advance.

The delegator represents a legal entity to which a corporate ID based on a delegated credential (VC) is issued. Depending on the nature of the legal entity, the delegator may be more than one person.

The deputy receives the delegated credential (VC) for creating the corporate ID, uses it for delegation certification, and makes a request for verification of a delegated credential-based presentation (VP included delegated VC) to perform the delegation act.

The system 10 for delegation based on a decentralized identifier issues a delegated credential (VC) for creating a corporate ID for the delegation certification to the deputy, and upon performing a delegation act, verifies the delegated credential-based presentation (VP included delegated VC) submitted by the deputy to determine whether to provide a service.

The system 10 for delegation based on a decentralized identifier verifies the deputy's verifiable presentation (VP), checks the delegator's decentralized identifier (DID), and then issues a delegated credential (VC).

In order for the deputy to perform a delegation act, the received delegated credential-based presentation (VP included delegated VC) must be generated to verify a proof of delegation.

The system 10 for delegation based on a decentralized identifier retrieves and verifies decentralized identifier information stored in a verifiable data registry using a decentralized identifier (DID) resolver.

Referring to FIG. 3, the system 10 for delegation based on a decentralized identifier may include a delegator 20, a deputy 30, an issuer 100, a verifier 200, a resolver 300, and a registry 400.

The issuer 100, which includes an issuer role in an existing decentralized identifier standard model, verifies the deputy' and delegator's information, and issues a delegated credential (VC) for delegation.

The issuer 100 may be excluded from a delegated subject, and a precondition prior to issuing a delegated credential (VC) must be in a state in which a pair of keys, a decentralized identifier, and a decentralized identifier (DID) document have been issued to both the delegator 20 and the deputy 30. In addition, a corporation must have designated a deputy in advance through an internal committee, or the like, to create a corporate ID. Under the assumption that the precondition is satisfied, the system 10 for delegation based on a decentralized identifier issues a delegated credential (VC), and issues and verifies a delegated credential-based presentation (VP included delegated VC).

Upon receiving a request for issuing the delegated credential (VC), the issuer 100 makes a request to the deputy 30 to submit a verifiable presentation (VP), and makes a request for verification from the verifier 200 when the submission is completed. The verifiable presentation (VP) for the deputy 30 includes a verifiable credential (VC) including terms regarding a legal relationship with the delegator 20.

In addition, in order to check the delegator 20, the issuer 100 makes a request to the verifier 200 to verify the validity of the decentralized identifier (DID).

The issuer 100 may issue a delegated credential (VC) when all verification is completed.

The issuer 100 issues a delegated credential (VC) including an issuance date, an expiration date, a deputy's and a delegator's decentralized identifiers, and detailed information on delegation (a field, an authorized delegation act, etc.). The issuer 100 may include the issuer's, delegator's, and deputy's signature values in the delegated credential (VC) to prove that the credential was issued under the delegator's and deputy's consent. When joint or a plurality of deputies exist, the issuer 100 may issue a delegated credential (VC) including of all participants' signature values.

The issuer 100 may issue and manage a delegated credential (VC) to prove the delegation of the deputy 30 who receives delegation. In this case, the issuer 100 cryptographically generates the information of the deputy 30 to be included in the delegated credential (VC) while hiding it to ensure anonymity. For example, the issuer 100 may set a validity period for the delegated credential (VC) to specify a delegation period for the start and end of delegation so that it can be used only during a specific period of time. In addition, the issuer 100 issues a delegated credential (VC) that can check the validity of a proof value, the authentication of all delegation participants, non-repudiation, and data forgery through a proof of the delegated credential (VC).

The deputy 30 may select the information of the delegated credential (VC) when submitting a delegated credential-based presentation (VP included delegated VC) to perform a delegation act. In addition, the deputy 30 may generate a delegated credential (VC)-based verifiable presentation (VP) to check the validity of a proof value, the authentication of the deputy, non-repudiation, and data forgery through a proof of the delegated credential (VC).

The deputy 30 submits the deputy's verifiable presentation (VP) to issue the delegated credential (VC), and must submit a delegated credential-based presentation (VP included delegated VC) to the verifier 200 in order to use a service for a delegation act.

The verifier 200 checks a legal relationship between the delegator 20 and the deputy 30 based on the deputy's verifiable presentation (VP). When the verification is completed, the verifier 200 notifies the issuer 100 of the result. The issuer 100 may issue a delegated credential (VC) when the legal relationship between the delegator 20 and the deputy 30 is proved.

In addition, the verifier 200 checks and proves a delegation period of the delegator 20 and the deputy 30, an authorized delegation act, and the like through the delegated credential (VC) including terms regarding the legal relationship with the delegator 20. The verifier 200 checks and proves a legal relationship regarding delegation between the delegator 20 and the deputy 30 through the delegated credential (VC) including terms regarding the legal relationship with the delegator 20 in the delegated credential-based presentation (VP included delegated VC).

The verifier 200 checks a standard or format of the delegated credential-based presentation (VP included delegated VC) to determine whether the delegated credential (VC) is included therein.

The verifier 200 verifies decentralized identifiers (DIDs) for the deputy 30 and the delegator 20. The verifier 200 verifies the validity of decentralized identifiers (DIDs) of the delegator 20 and the deputy 30. The verifier 200 retrieves and verifies a decentralized identifier (DID) document stored in the registry 400 in connection with one or more blockchains through the resolver 300.

The verifier 200 checks the validity of a proof of the verifiable presentation (VP). Specifically, the verifier 200 retrieves the submitter's (deputy's) decentralized identifier (DID) document stored in the registry 400 through the resolver 300 to verify the relevant verifiable presentation. The verifier 200 performs the verification of the relevant verifiable presentation (VP) through a public key included in the retrieved decentralized identifier (DID) document, and determines its validity.

When the verifiable presentation (VP) is valid, the verifier 200 verifies the verifiable credentials (VC) included in the verifiable presentation (VP). The verifier 200 checks whether the verifiable credential (VC) included in the verifiable presentation (VP) has expired. For example, the verifier 200 may verify the delegated credential (VC) included in the delegated credential-based presentation (VP included delegated VC), and check whether the delegated credential (VC) has expired.

The verifier 200 checks the validity of signature values for all delegation participants (delegators and deputies). Here, the verifier 200 may apply batch verification that efficiently verifies multiple signature values for the same message. Specifically, the verifier 200 may efficiently verify N signature value verifications to be performed for all N delegation participants through batch verification through only one verification.

The verifier 200 receives the delegated credential-based presentation (VP included delegated VC) to perform a proof of delegation, and retrieves and verifies the metadata of the relevant decentralized identifier (DID) from the registry 400 through the resolver 300. Through this, the system 10 for delegation based on a decentralized identifier may determine whether to provide a service.

The resolver 300 may manage one or more decentralized identifier (DID) resolvers in a multi-layer manner to manage access information on a blockchain. The resolver 300 may access one or more blockchains or heterogeneous blockchains.

The registry 400 is a verifiable data registry that stores metadata about a decentralized identifier (DID). For example, the registry 400 may use a blockchain that stores a distributed ledger for a decentralized identifier environment capable of self-sovereign identity verification. The registry 400 supports one or more or heterogeneous blockchain environments using the resolver 300.

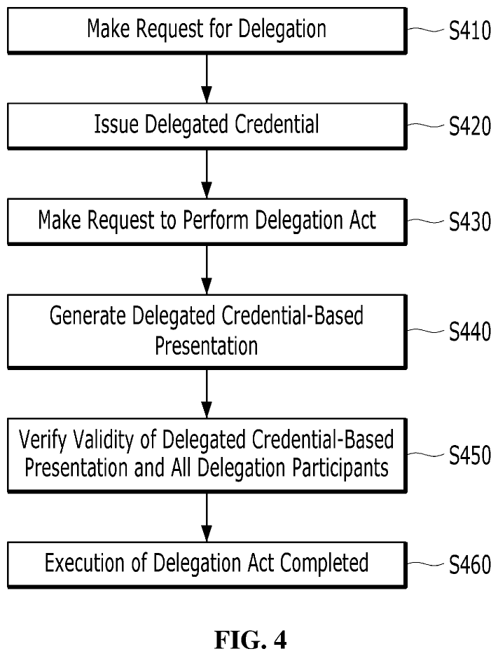

FIG. 4 is a diagram illustrating a method for delegation based on a decentralized identifier according to an embodiment of the present disclosure. Each process described below is a process performed by each functional unit constituting a system for delegation based on a decentralized identifier, but for simplicity and clarity of the description of the present disclosure, a subject in each step is collectively referred to as the system for delegation based on a decentralized identifier.

Referring to FIG. 4, the system 10 for delegation based on a decentralized identifier receives a request for delegation including information on the deputy 30 and the delegator 20 in step S410. For example, the system 10 for delegation based on a decentralized identifier may submit the deputy's verifiable presentation (VP) and the delegator's decentralized identifier (DID) together.

In step S420, the system 10 for delegation based on a decentralized identifier issues a delegated credential (VC). For example, the system 10 for delegation based on a decentralized identifier verifies the validity of the deputy's verifiable presentation (VP) and the delegator's decentralized identifier (DID), and then issues a delegated credential (VC). The system 10 for delegation based on a decentralized identifier retrieves the deputy's or delegator's decentralized identifier document (DIDDOCU) stored in the registry 400 through the resolver 300 and uses the document to check its validity.

In step S430, the system 10 for delegation based on a decentralized identifier receives a request for verification for performing a delegation act of the deputy 30.

In step S440, the system 10 for delegation based on a decentralized identifier generates a delegated credential-based presentation (VP included delegated VC) that can be verified with the deputy's signature value. For example, the delegated credential-based presentation (VP included delegated VC) includes a delegation period, an authorized delegation act, and the like, between the delegator 20 and the deputy 30 through the delegated credential (VC) including terms regarding a legal relationship between the delegator 20 and the deputy 30.

In step S450, the system 10 for delegation based on a decentralized identifier verifies that the requested delegation act is authorized. For example, the system 10 for delegation based on a decentralized identifier checks and proves a legal relationship regarding delegation between the delegator 20 and the deputy 30 through the delegated credential (VC) including terms regarding the legal relationship with the delegator 20 in the delegated credential-based presentation (VP included delegated VC). The system 10 for delegation based on a decentralized identifier may verify the validity of all delegation participants using the deputy's, delegator's, and issuer's decentralized identifier document (DIDDOCU).

In step S460, the system 10 for delegation based on a decentralized identifier allows the deputy 30 to perform a delegation act when all verification is completed.

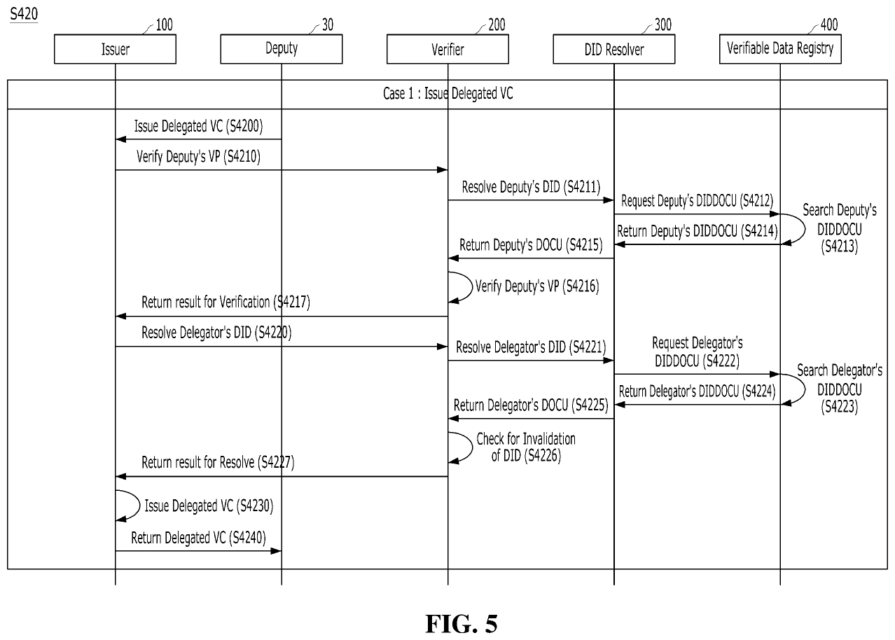

FIGS. 5 to 7 are exemplary diagrams of a method for delegation based on a decentralized identifier according to an embodiment of the present disclosure.

The example of FIG. 5 is a detailed process in which the system 10 for delegation based on a decentralized identifier issues a delegated credential (VC).

Referring to FIG. 5, the system 10 for delegation based on a decentralized identifier may issue a delegated credential (VC). Specifically, the issuer 200 may receive a delegated credential (VC) at the request of the deputy 30.

In step S4200, the deputy 30 makes a request to the issuer 100 to issue a delegated credential. At this time, the deputy 30 must submit information to check a delegator who has granted delegation and a deputy who has received delegation. For example, the deputy's verifiable presentation (VP) and the delegator's decentralized identifier (DID) must be submitted to check the delegator's identity. Here, the submitted deputy's verifiable presentation (VP) includes personal information that corresponds to legal requirements and personal information that can prove a legal relationship with the delegator.

In step S4210, the issuer 100 requests verification from the verifier 200 for the deputy's verifiable presentation (VP) that has been received to check the deputy 30.

Specifically, in step S4211, the verifier 200 resolves the deputy's decentralized identifier (DID) through the resolver 300 to verify the deputy's verifiable presentation (VP).

In steps S4212 to S4214, the verifier 200 retrieves the submitter's (deputy's) decentralized identifier document (DIDDOCU) stored in the registry 400.

In step S4216, the verifier 200 verifies the deputy's verifiable presentation (VP) through a public key included in the retrieved decentralized identifier document (DIDDOCU) to determine its validity.

In step S4217, the verifier 200 transmits the verification result to the issuer 100.

In step S4220, the issuer 100 verify its validity through the delegator's decentralized identifier (DID).

In step S4221, the issuer 100 resolves the delegator's decentralized identifier (DID) through the resolver 300.

In steps S4222 to S4224, the verifier 200 retrieves the delegator's decentralized identifier document (DIDDOCU) stored in the registry 400.

In step S4226, the verifier 200 determines its validity through the delegator's decentralized identifier (DID).

In case the verification result is valid, in step S4230, the issuer 100 may issue a delegated credential (VC) based on internal presentation information and delegation information. For example, the delegated credential (VC) may include not only an issuance period and an expiration period, but also the deputy's and delegator's decentralized identifier, time information indicating the start and end of a delegation period, and detailed information on delegation (field, delegation act, etc.). The detailed information on delegation consists of information that satisfies the legal requirements of a general power of attorney. In addition, in a similar manner to the existing decentralized identifier model, the issuer has an authority to issue a credential (VC), and the issuance of a delegated credential (VC) includes an important proof element that a delegator who has granted delegation and a deputy has received delegation have proceeded together. Therefore, the system 10 for delegation based on a decentralized identifier may include the issuer's, delegator's, and deputy's signature values to prove the delegated credential (VC). In addition, the system 10 for delegation based on a decentralized identifier may be configured with a total number of participants involved in delegation and signature values corresponding thereto for a case where joint or multiple delegators exist.

In the case of issuing a delegated credential in the system 10 for delegation based on a decentralized identifier, the issuer may cryptographically generate the information of the deputy to be included in the credential while hiding it to ensure anonymity. In addition, the system 10 for delegation based on a decentralized identifier may set a validity period for the credential (VC) to specify a delegation period for the start and end of delegation so that it can be used only during a specific period of time. In addition, the system 10 for delegation based on a decentralized identifier may verify the validity of a proof value, the authentication of all delegation participants, non-repudiation, and data forgery through a proof of the delegated credential (VC).

In step S4240, the issuer 100 transmits the issued delegated credential (VC) to the deputy 30.

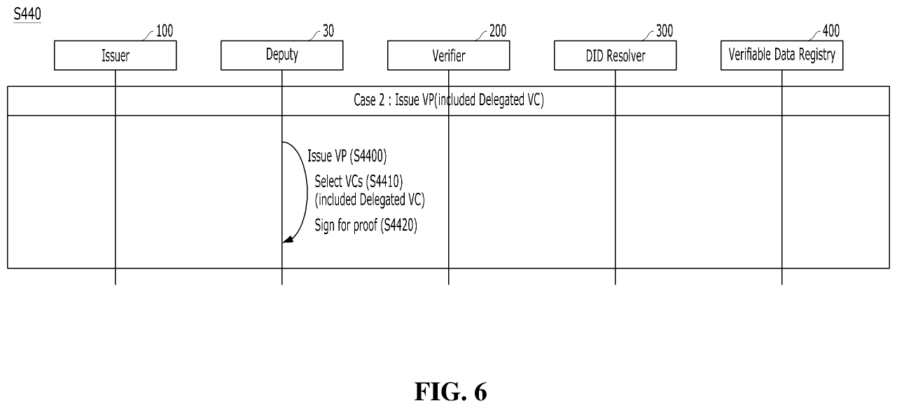

The example of FIG. 6 is a detailed process in which the system 10 for delegation based on a decentralized identifier issues a delegated credential-based presentation (VP included delegated VC).

Referring to FIG. 6, in step S4400, the deputy 30 receives a delegated credential-based presentation (VP included delegated VC).

Specifically, in step S4410, the deputy 30 selects one or more delegated credentials (VCs) including the received delegated credential (VC).

In step S4420, the deputy 30 uses a signature of the deputy 30 as a proof of the delegated credential-based presentation (VP included delegated VC). Since an authority of issuing the presentation belongs to the submitter (deputy), a signature value of the deputy 30 is included in the proof of the delegated credential-based presentation (VP included delegated VC).

When the system 10 for delegation based on a decentralized identifier issues a delegated credential-based presentation (VP included delegated VC), the deputy 30 may selectively hide information. The system 10 for delegation based on a decentralized identifier may verify the validity of a proof value, the authentication of all delegation participants, non-repudiation, and data forgery through a proof of the delegated credential-based presentation (VP included delegated VC) in a similar manner to the proof of the delegated credential (VC).

In the case of verifying the delegated credential-based presentation (VP included delegated VC) in the system 10 for delegation based on a decentralized identifier, the verifier 200 may verify its validity without acquiring any personal information about the deputy's information.

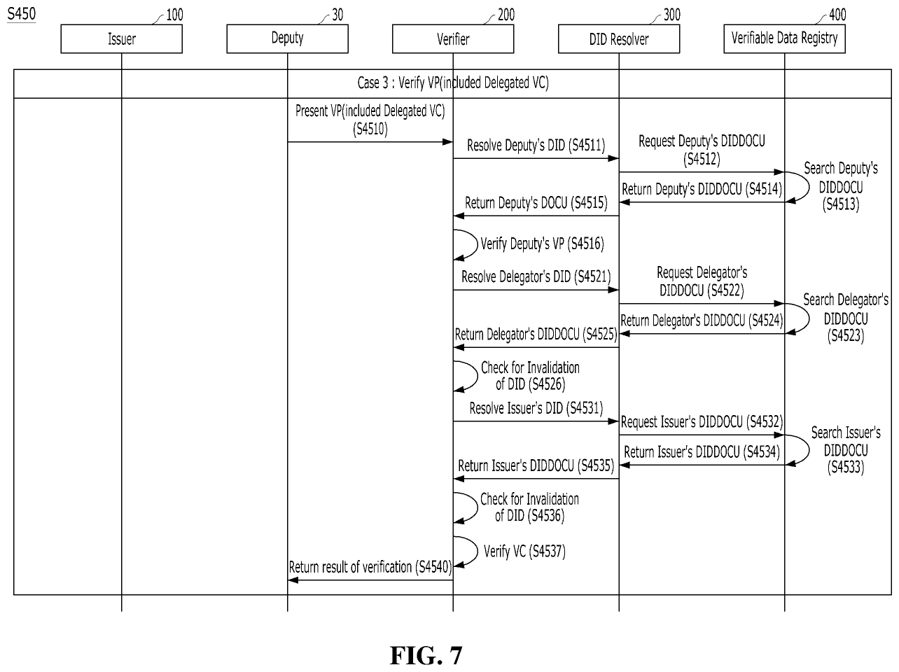

The example of FIG. 7 is a detailed process in which the system 10 for delegation based on a decentralized identifier verifies the delegated credential-based presentation (VP included delegated VC).

The verifier 200 checks a standard of the delegated credential-based presentation (VP included delegated VC) to determine whether the delegated credential (VC) is included therein.

Furthermore, the verifier 200 retrieves the submitter's (deputy's) decentralized identifier document (DIDDOCU) through the resolver 300 to verify the delegated credential-based presentation (VP included delegated VC).

The system 10 for delegation based on a decentralized identifier may verify the delegated credential-based presentation (VP included delegated VC) through a public key included in the acquired deputy's document (DIDDOCU) to determine its validity.

Referring to FIG. 7, the system 10 for delegation based on a decentralized identifier may verify a delegated credential-based presentation (VP included delegated VC).

In step S4510, the deputy 30 submits a delegated credential-based presentation (VP included delegated VC) to the verifier 200 to prove the delegation.

The verifier 200 performs detailed verification on the delegated credential-based presentation (VP included delegated VC). Specifically, the verifier 200 checks the deputy's, delegator's and issuer's decentralized identifiers (DIDs), and verifies the validity of all delegation participants and the validity of the delegated credential-based presentation (VP included delegated VC) using the decentralized identifier document (DIDDOCU).

First, in step S4511, the verifier 200 resolves the deputy's decentralized identifier (DID) through the resolver 300.

In step S4512, the resolver 300 makes a request for the submitter's (deputy's) decentralized identifier document (DIDDOCU) stored in the registry 400.

In step S4513, the registry 400 searches for and retrieves the submitter's (deputy's) decentralized identifier document (DIDDOCU).

In steps S4514 and S4515, the verifier 200 retrieves the decentralized identifier document (DIDDOCU) through the resolver 300.

In step S4516, the verifier 200 verifies the delegated credential-based presentation (VP included delegated VC) using a public key of the decentralized identifier document (DIDDOCU).

In case it is not valid, it means that it is not the deputy's delegated credential-based presentation (VP included delegated VC) or has been forged.

In step S4521, the verifier 200 resolves the delegator's decentralized identifier (DID) through the resolver 300.

In step S4522, the resolver 300 makes a request for the delegator's decentralized identifier (DID) stored in the registry 400.

In step S4523, the registry 400 searches for and retrieves the delegator's decentralized identifier document (DIDDOCU).

In steps S4524 and S4525, the verifier 200 retrieves the delegator's decentralized identifier document (DIDDOCU) through the resolver 300.

In step S4526, the verifier 200 checks the validity of the delegated credential-based presentation (VP included delegated VC) through a public key of the delegator's decentralized identifier document (DIDDOCU).

In step S4531, the verifier 200 resolves the issuer's decentralized identifier (DID) through the resolver 300.

In step S4532, the resolver 300 makes a request for the issuer's decentralized identifier (DID) stored in the registry 400.

In step S4533, the registry 400 searches for and retrieves the issuer's decentralized identifier document (DIDDOCU).

In steps S4534 and S4525, the verifier 200 retrieves the issuer's decentralized identifier document (DIDDOCU) through the resolver 300.

In step S4536, the verifier 200 checks the validity of the delegated credential-based presentation (VP included delegated VC) through a public key of the issuer's decentralized identifier document (DIDDOCU).

In case all validity examinations in the previous step are passed, in step S4537, the verifier 200 verifies the delegated credential (VC). In the case of a delegated credential (VC), the system 10 for delegation based on a decentralized identifier must verify the validity of signature values for all participants. A batch verification that efficiently verifies multiple signature values for the same message is applied thereto. The system 10 for delegation based on a decentralized identifier may efficiently verify N signature value verifications to be performed for all N participants through the batch verification with only one verification.

In step S4540, the verifier 200 transmits a verification result of the delegated credential (VC) to the deputy 30.

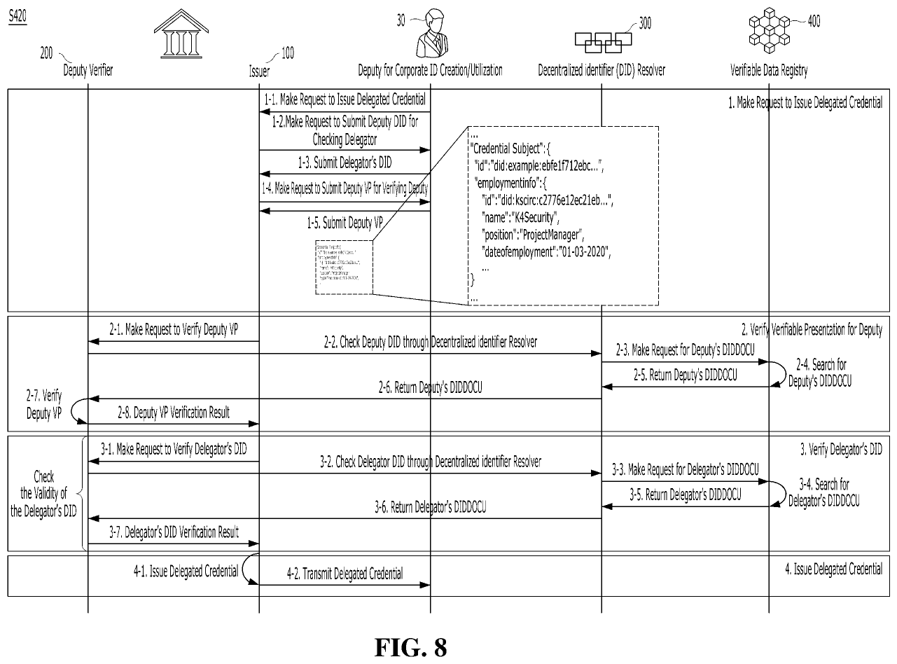

FIG. 8 is an example of a delegated credential issuance scenario for creating a corporate ID in a system for delegation based on a decentralized identifier according to an embodiment of the present disclosure.

Referring to FIG. 8, the system 10 for delegation based on a decentralized identifier 1. receives a request for issuing a delegated credential (VC), 2. verifies a deputy's verifiable presentation (VP), 3. checks the validity of the delegator's decentralized identifier (DID), and then 4. issues the delegated credential (VC).

### 1. Delegated Credential (VC) Issuance Request Scenario

1-1. The deputy 30 makes a request to the issuer 100 to issue a delegated credential (VC) to create a corporate ID.

1-2. The issuer 100 makes a request to the deputy 30 to submit the delegator's decentralized identifier (DID) to check the delegator.

1-3. The deputy 30 submits the delegator's decentralized identifier (DID) to the issuer 100.

1-4. Since the identity of the deputy 30 must be verified in order to issue a delegated credential (VC) for creating a corporate ID to the deputy 30, the issuer 100 makes a request to the deputy 30 to submit the deputy's verifiable presentation (VP)

1-5. The deputy 30 submits his or her own (deputy's verifiable presentation (VP) to the verifier 200. At this time, the verifier 200 checks the issuer's and deputy's identities through the verifiable credential (VC) including terms regarding a legal relationship with the delegator (corporation) in the deputy's verifiable presentation (VP).

### 2. Deputy's Verifiable Presentation (VP) Verification Scenario

2-1. The issuer 100 makes a request to the verifier 200 to verify the deputy's verifiable presentation (VP).

2-2. The verifier 200 checks the deputy's decentralized identifier (DID) through the resolver 300.

2-3. The resolver 300 makes a request to the registry 400 for the deputy's decentralized identifier document (DIDDOCU).

2-4. The registry 400 searches for the deputy's decentralized identifier document (DIDDOCU).

2-5. The registry 400 returns the searched deputy's decentralized identifier document (DIDDOCU) to the resolver 300.

2-6. The resolver 300 returns the deputy's decentralized identifier document (DIDDOCU) to the verifier 200.

2-7. The verifier 200 verifies the deputy's verifiable presentation (VP) using the deputy's decentralized identifier document (DIDDOCU). Through this, the identity of the deputy 30 is checked. For example, in the verifiable presentation (VP), there is a verifiable credential (VC) including information on a legal relationship with a corporation, such as a serial employee number or a proof of employment. The verifier 200 proves the legal relationship between the delegator (corporation) and the deputy 30 through this verifiable credential (VC).

2-8. The verifier 200 transmits a verification result of the deputy's verifiable presentation (VP) to the issuer 100.

### 3. Delegator's Decentralized Identifier (DID) Validity Checking Scenario

3-1. The issuer 100 makes a request to the verifier 200 to verify the delegator's decentralized identifier (DID).

3-2. The verifier 200 checks the delegator's decentralized identifier (DID) through the resolver 300

3-3. The resolver 300 makes a request to the registry 400 for the delegator's decentralized identifier document (DIDDOCU).

3-4. The registry 400 searches for the delegator's decentralized identifier document (DIDDOCU).

3-5. The registry 400 returns the searched delegator's decentralized identifier document (DIDDOCU) to the resolver 300.

3-6. The resolver 300 returns the delegator's decentralized identifier document (DIDDOCU) to the verifier 200.

3-7. The verifier 200 transmits a verification result of the delegator's decentralized identifier (DID) to the issuer 100.

### 4. Delegated Credential (VC) Issuance Scenario

4-1. Based on verification procedures of 1, 2, and 3 described above, the issuer 100 issues a delegated credential (VC) for a corporate ID.

4-2. The issuer 100 transmits the issued delegated credential (VC) for a corporate ID to the deputy 30.

The content of delegation information is specifically defined in the issued delegated credential (VC). For example, “Type” of “CredentialSubject” may be defined as “”, and information of the delegator 20 and the deputy 30, a delegation period, a validity period of the relevant credential (VC), and the like, may be defined in the “CredentialSubject”. Signing is proceeded after defining all relevant attributes, and a signature value is defined in the “proof” attribute. Since the delegated credential (VC) is a method based on delegation consisting of the delegator (corporation) 20 and the deputy 30, it is an important element that the delegator (corporation) 20 and the deputy 30 have proceeded together. Therefore, the signature value of the delegated credential (VC) may be configured as {sig1: “issuer's signature”, sig2: “delegator's signature”, sig3: “representative's signature”}. Here, there may be one or more deputies, and the signature value must include all deputies' signatures.

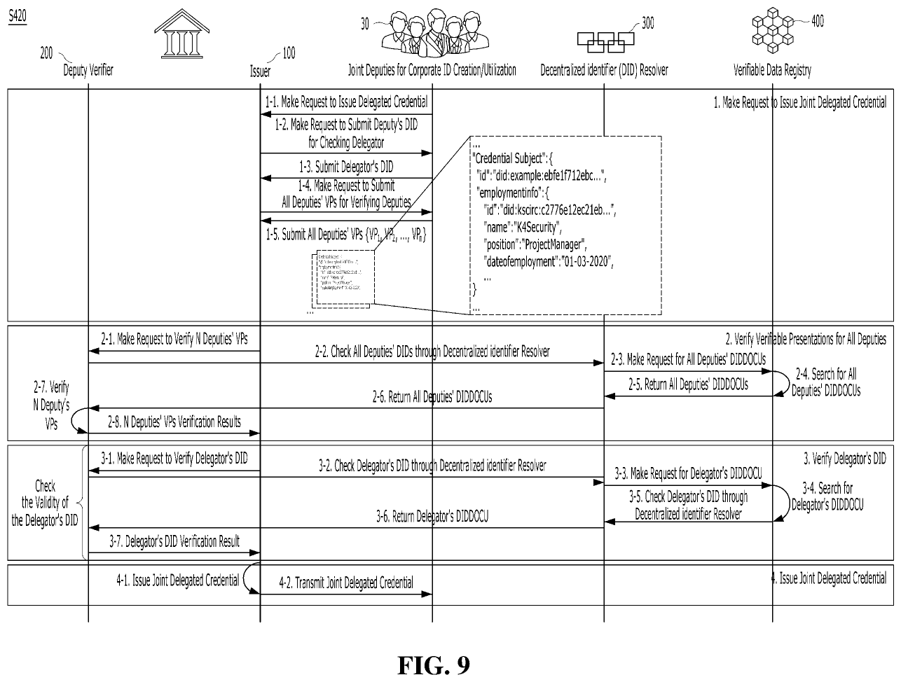

FIG. 9 is an example of a delegated credential issuance scenario for creating a joint-based corporate ID in a system for delegation based on a decentralized identifier according to an embodiment of the present disclosure.

In case where a corporation is in its sole name, a single deputy 30 may possess a delegation authority, but in the case of a joint-based corporation, there may be more than one deputy 30. When the number of deputies 30 is N, it is assumed that a representative deputy is set among the N deputies, and an ID for creating a joint corporate ID has been issued for the relevant representative deputy.

Referring to FIG. 9, the system 10 for delegation based on a decentralized identifier 1. receives a request for issuing a joint delegated credential, 2. verifies all deputies' verifiable presentation (VP), 3. checks the validity of the delegator's decentralized identifier (DID), and then 4. issues a joint delegated credential (VC).

In the case of issuing a joint delegated credential, since there are more than one deputy, the verifier 200 must verify all N deputies' verifiable presentations (VPs). The verifier 200 verifies all deputies' identities.

In addition, when there are N deputies, the system 10 for delegation based on a decentralized identifier may specify the “Type” of the “CredentialSubject” of the joint delegated credential (VC) as “JointTenancyCorporateVerifiableCredential”. In addition, the signature value of the joint delegated credential (VC) may be configured as {sig1: “issuer's signature”, sig2: “delegator's signature”, sig3: “deputy-1′s signature”, . . . , sig(N+2): “deputy-N′s signature”}. The signature value of a joint delegated credential (VC) must include all delegates' signatures. Here, a group of N deputies receives the signatures of other deputies under the leadership of a representative deputy, and then generates a final joint delegated credential (VC) by specifying them in the “Proof” attribute.

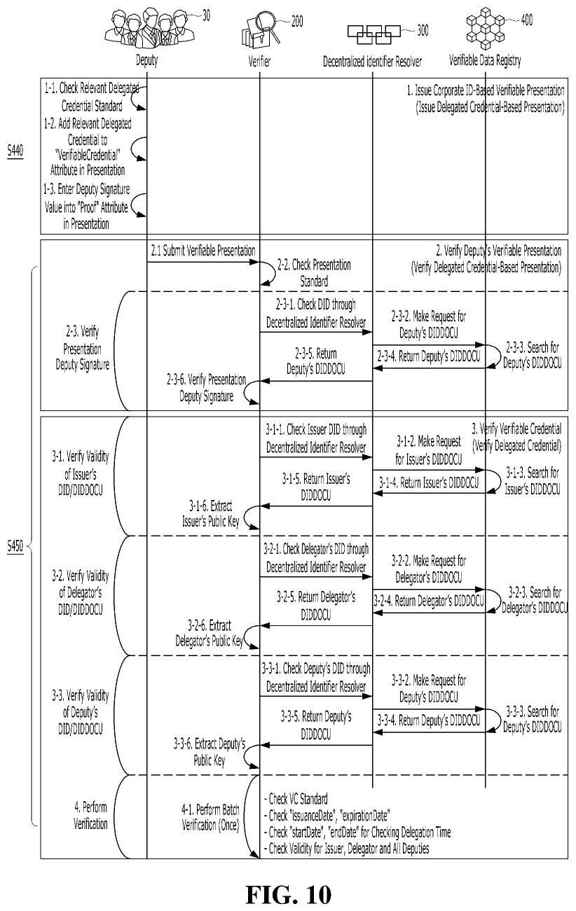

FIG. 10 is an example of a delegated credential-based presentation issuance and verification scenario in a system for delegation based on a decentralized identifier according to an embodiment of the present disclosure.

Referring to FIG. 10, the system 10 for delegation based on a decentralized identifier includes the steps of 1. issuing a delegated credential-based presentation (VP included delegated VC), 2. verifying the delegated credential-based presentation (VP included delegated VC), and 3. verifying the delegated credential (VC).

### 1. Delegated Credential-Based Presentation Issuance Scenario

1-1. Check a standard of a delegated credential (VC).

1-2. Add the relevant delegated credential to the “VerifiableCredential” attribute in the delegated credential-based presentation.

1-3. Enter a deputy signature value into the “Proof” attribute in the delegated credential-based presentation.

### 2. Delegated Credential-Based Presentation (VP Included Delegated VC) Verification Scenario

2-1. Submit a delegated credential-based presentation (VP included delegated VC) to the verifier 200.

2-2. The verifier 200 checks a standard for the relevant delegated credential-based presentation (VP included delegated VC).

2-3. The verifier 200 retrieves a decentralized identifier document (DIDDOCU) for a decentralized identifier (DID) of the deputy 30 to check its validity, and verifies a deputy signature of the delegated credential-based presentation (VP included delegated VC).

### 3. Delegated Credential (VC) Verification Scenario

3-1. The verifier 200 retrieves a decentralized identifier document (DIDDOCU) for a decentralized identifier (DID) of the issuer 100 specified in a delegated credential to check its validity, and extracts the issuer's public key.

3-2. The verifier 200 retrieves the decentralized identifier document (DIDDOCU) for the decentralized identifier (DID) of the deputy 20 specified in the delegated credential to check its validity, and extracts the deputy's public key.

3-3. The verifier 200 retrieves the decentralized identifier document (DIDDOCU) for the decentralized identifiers (DIDs) of all one or more deputies 30 specified in the delegation credential to check its validity, and extracts the deputy's public key.

3-4. The verifier 200 performs batch verification (once) using the extracted public key. In detail, the verifier 200 checks the standard of the delegated credential (VC), issuance and expiration periods, the validity of a delegation period, and the like.

The foregoing method for delegation based on a decentralized identifier may be implemented as computer-readable codes on a computer-readable medium. The computer-readable recording medium may be, for example, a removable recording medium (CD, DVD, Blu-ray disc, USB storage device, removable hard disk) or a fixed recording medium (ROM, RAM, computer-equipped hard disk). The computer program recorded on the computer readable recording medium may be transmitted to another computing device via a network such as internet and installed in the other computing device, thereby being used in the other computing device.

In the above description, it is described that all the components constituting the embodiments of the present disclosure are combined or operated as one, but the technical features of the present disclosure are not limited to these embodiments. That is, within the scope of the present disclosure, all of the components may be selectively combined and operated in one or more combinations.

Although operations are shown in a specific order in the drawings, it should not be understood that desired results can be obtained when the operations must be performed in the specific order or sequential order or when all of the operations must be performed. In certain circumstances, multitasking and parallel processing may be advantageous. Moreover, in the above-described embodiments, it should not be understood that the separation of various configurations is necessarily required, and it should be understood that the described program components and systems may generally be integrated together into a single software product or be packaged into multiple software products.

So far, the present disclosure has been described around the embodiments thereof. It will be apparent to those skilled in this art that various modifications may be made thereto without departing from the gist of the present disclosure. Accordingly, it should be noted that the embodiments disclosed in the present disclosure are merely illustrative but not restrictive to the concept of the present disclosure. The scope of the present disclosure is defined by the appended claims rather than the foregoing description, and all differences within the equivalent scope of the invention should be construed to be included in the present disclosure.

What is claimed is:

1. A system for delegation based on a decentralized identifier, the system comprising:
an issuer that checks a deputy's and a delegator's identity information, and issues a delegated credential for delegation;
a verifier that retrieves and verifies the meta data of the decentralized identifier; and
a registry that stores the meta data of the decentralized identifier.

2. The system of claim 1, wherein the issuer issues a delegated credential of a legal entity.

3. The system of claim 1, wherein the verifier verifies a delegated credential-based presentation (VP) submitted by a deputy to perform a delegation act.

4. The system of claim 1, wherein the delegated credential comprises at least one of an issuance period, an expiration period, a deputy's and a delegator's decentralized identifiers, time information indicating the start and end of a delegation period, a delegation field, and a delegation act.

5. The system of claim 1, wherein the delegated credential comprises one or more deputy information in case the delegator is a joint name.

6. A method for delegation performed by a system for delegation based on a decentralized identifier, the method comprising:
receiving a request for delegation from a deputy;
issuing a delegated credential;
receiving a request for verification to perform a delegation act;
verifying that the delegation act has been authorized; and
allowing the deputy to perform a delegation act.

7. The method of claim 6, wherein the receiving a request for delegation from a deputy uses the deputy's verifiable presentation and the delegator's decentralized identifier.

8. The method of claim 6, wherein the receiving a request for delegation from a deputy makes a request for delegation to a legal entity.

9. The method of claim 6, wherein the delegated credential comprises one or more deputy information in case the delegator is a joint name.

10. The method of claim 6, wherein the delegated credential comprises at least one of an issuance period, an expiration period, a deputy's and a delegator's decentralized identifiers, time information indicating the start and end of a delegation period, a delegation field, and a delegation act.

11. A computer program recorded on a computer-readable recording medium that executes the method of claim 6.
